(19) United States
(12) Patent Application Publication
(10) Pub. No.: US 2004/0174975 A1
(43) Pub. Date: Sep. 9, 2004

(54) Common call routing for multiple telephony devices

(75) Inventors: Dany Sylvain, Gatineau (CA); Stephen Bennett Elliott, Allen, TX (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/382,247

(22) Filed: Mar. 5, 2003

(51) Int. Cl. H04M 3/42

(52) U.S. Cl. 379/211.01; 379/211.02

(57) ABSTRACT

The present invention provides a service node capable of coordinating call processing for incoming calls intended for any one of multiple telephony devices of a given entity, such as a business or individual user. Switching devices, such as traditional telephony switches or internetworked gateways controlling call routing, are configured to interact with a service node to determine how to handle incoming calls to the telephony devices that they serve. As such, call processing rules, which are established by the entity, are applied to an incoming call to any of the entity's telephony devices to effectively route calls to other ones of the telephone devices, route the call to a desired voicemail system, provide call screening or blocking, and any other desired call control activity. Based on the call processing rules for the given entity, the service node will instruct the corresponding telephony switches to handle the incoming call.

### FIELD OF THE INVENTION

The present invention relates to call processing, and in particular to providing common call routing for multiple telephony devices associated with a given user or entity.

### BACKGROUND OF THE INVENTION

Telephony users today have multiple communication devices with which to stay in touch with the world. Managing these various communication devices in a consistent and efficient manner is increasingly challenging. Callers trying to contact a user often do not know which directory number should be used to reach the user, and will often have to make multiple call attempts, and in the process, leave multiple voicemails in different voicemail systems of the user. Attempts to minimize these complications have led to “one number” services, where a user can adopt a single directory number for multiple telephony devices. Unfortunately, these services are not widely available, and have proven difficult to implement across different communication technologies and different service providers. Further, the one number approach often forces a user to adopt a new directory number, which is typically undesirable once the original directory numbers have become widely known and used by other parties.

Accordingly, there is a need for a way to allow a user to efficiently and effectively control how incoming calls are routed between multiple telephony devices associated with the user, regardless of the telephony device for which the call was originally intended. There is a further need to provide a single voicemail system for a user wherein calls directed to a variety of telephony devices can be routed to the single voicemail system when unanswered. There is a further need to allow the user to establish various rule sets to control the routing of incoming calls between the various telephony devices based on the general state of the user, when the incoming call occurs, which telephony device was originally called, or the identity of the caller.

### SUMMARY OF THE INVENTION

The present invention provides a service node capable of coordinating call processing for incoming calls intended for any one of multiple telephony devices of a given entity, such as a business or individual user. Switching devices, such as traditional telephony switches or internetworked gateways controlling call routing, are configured to interact with a service node to determine how to handle incoming calls to the telephony devices that they serve. As such, call processing rules, which are established by the entity, are applied to an incoming call to any of the entity's telephony devices to effectively route calls to other ones of the telephone devices, route the call to a desired voicemail system, provide call screening or blocking, and any other desired call control activity. Based on the call processing rules for the given entity, the service node will instruct the corresponding telephony switches to handle the incoming call. Each entity may have numerous profiles associated with different sets of call processing rules wherein the profiles can be selectively activated to provide customized call handling for different scenarios or circumstances.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 provides an exemplary communication environment according to one embodiment of the present invention.

FIG. 2 is a flow diagram providing an operational overview of the present invention according to one embodiment.

FIGS. 3A and 3B are an exemplary call flow diagram for a first scenario according to one embodiment of the present invention.

FIGS. 4A and 4B are an exemplary call flow diagram for a second scenario according to one embodiment of the present invention.

FIG. 5 is a block representation of a service node constructed according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows a user associated with multiple telephony devices having unique directory numbers or addresses to establish rules for controlling the routing of these calls to one of the telephony devices associated with the user or to a common voicemail system. Regardless of the telephony device being called, the incoming call may be routed, blocked, screened, or otherwise handled according to a defined set of rules, automatically and without the need for interaction by the caller or the called party. As an example, a call originated by a caller to a first telephony device associated with the called party may be automatically rerouted to a second telephony device associated with the called party if the caller has a certain identity, wherein the call would otherwise be routed to voicemail. As described below and as will be recognized by those skilled in the art, the present invention provides tremendous flexibility in allowing the called party to control routing of incoming calls in an automated fashion for all of the called party's telephony devices, even those associated with different networks and network technologies. Further detail regarding the operation of the present invention and select examples are provided after an overview of the communication environment architecture capable of implementing the concepts of the present invention.

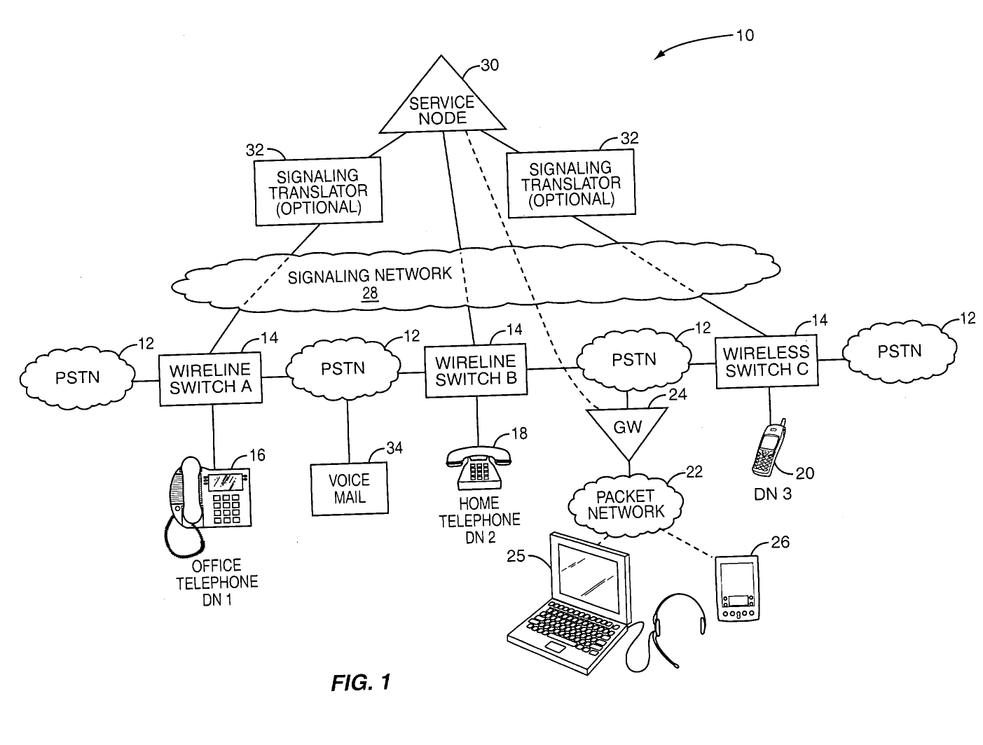

With reference to FIG. 1, a communication environment 10 is illustrated as being centered about the public switched telephone network (PSTN) 12, which is operatively coupled to other networks supporting wireless and packet-based communications. Traditionally, telephony switches, such as wireline switches 14 (A and B) are associated with the PSTN 12 and serve respective telephony devices, such as the office telephone 16, which is serviced by wireline switch 14A, and a home telephone 18, which is serviced by wireline switch 14B. The office telephone 16 and the home telephone 18 have respective directory numbers (DNs) DN 1 and DN 2. Calls intended for either of these telephony devices are generally routed via the respective wireline switches 14A and 14B.

For wireless communications, a wireless switch 14 (C), such as a mobile switching center (MSC), will support communications with a mobile terminal 20, such as a wireless telephone or wireless personal digital assistant (PDA). Assume that the mobile terminal 20 is associated with a directory number, DN 3, and all calls routed to the mobile terminal 20 will be routed through the appropriate wireless switch 14C.

For packet-based telephony, such as voice over packet (VoP), interaction between a packet network 22 and the PSTN 12 is facilitated through a gateway 24, which will effectively convert between circuit-switched and packet-switched voice information. Packet telephony may be facilitated via any number of devices, including a personal computer (PC) 25, PDA 26, and packet-based telephones, not shown.

Call processing, including call routing and control, is preferably provided via a signaling network 28, such as the Signaling System 7 (SS7), which will directly or indirectly interact with the wireline switches 14A and 14B, wireless switch 14C, and perhaps the gateway 24 to facilitate the establishment of telephony calls between various telephony devices. For implementation of the present invention, a call control entity referred to generally as a service node 30 will directly or indirectly through the signaling network 28 communicate with the wireline switches 14A and 14B, wireless switch 14C, and the gateway 24, to process calls directed to any of the user's telephony devices that are illustrated in FIG. 1. Alternatively, call processing signaling may be provided via a packet-based protocol such as SIP (Session Initiation Protocol, IETF standard RFC 3261) between the service node 30 and packet-based devices such as gateway 24 or PC 25. Depending on the capabilities of the various telephony switches 14, the gateway 24, and the signaling network 28, optional signaling translators 32 may be provided to facilitate an interface between the service node 30 and the various telephony switches 14 and gateway 24. The signaling translators 32 may provide protocol and signaling translations as necessary to enable the service node 30 and the various telephony switches 14 and gateway 24 to communicate.

Importantly, the illustrated example assumes that the office telephone 16, home telephone 18, personal computer 25 and mobile terminal 20 are all devices having different directory numbers or network addresses and are all associated with a single user. The respective telephony switches 14A, 14B, and 14C are provisioned to effectively request call processing instructions from the service node 30, and will process the call based on the response received from the service node 30. The service node 30 will decide how to route the incoming call based on rules established by the user. The service node 30 may reroute the incoming call to another of the user's telephony devices, block the call, or forward the call to a voicemail system 34, which will preferably be the only voicemail system 34 for the user, regardless of the telephony device for which the incoming call was originally intended. The call processing rules may be a function of virtually any criteria, such as time or date, line status, mobile terminal location, computer presence, an electronic calendar, the caller, or the called number, such that calls from different people may be handled in different ways based on any combination of those criteria. Further, the call processing may be based all or in part on the originally intended directory number dialed by the caller.

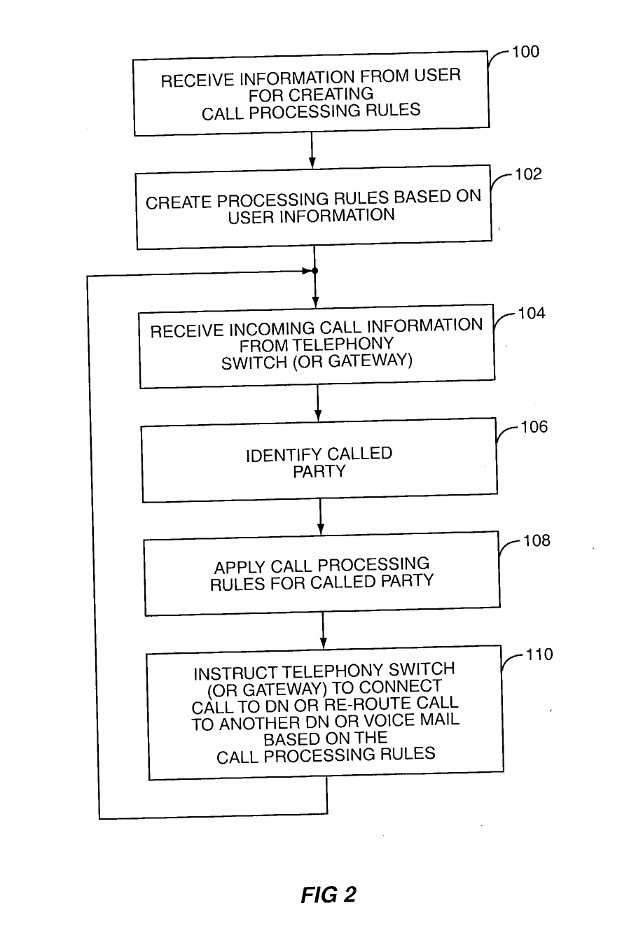

With reference to FIG. 2, the basic functionality of a service node 30 is illustrated. Initially, the service node 30 will receive information from the user to create the call processing rules (step 100). The call processing rules will essentially be a profile identifying how to process an incoming call based on the chosen variables. Preferably, the user may access the service node 30 via any number of devices, including a personal computer, PDA, or telephone, directly or indirectly via an interactive voice response system. Those skilled in the art will recognize the multitude of ways for allowing a user to interact with the service node 30 to effectively establish the call processing rules. Interaction with the service node 30 via the computer or PDA is preferably done via a browser interface in traditional fashion. Preferably, the user is able to set up different types of profiles having different call processing rule sets, such that call processing is handled differently given the current state of the user. For example, different call processing rules may be established when the user is in the office, at home, telecommuting, traveling, on vacation, out of the office, or in a meeting.

Once the information to create the call processing rules is received (step 100), rules are then created based on the user information and put into effect (step 102). Preferably, each of the telephony switches 14 or gateways 24 are provisioned to interact with the service node 30 to receive call processing instructions upon receiving a call directed to a telephony device associated with the user.

Once provisioned, the various telephony switches 14 and gateways 24 will recognize an incoming call intended for the user, and initiate interaction with the service node 30. The service node 30 will receive the incoming call information from the telephony switches 14 or gateways 24 handling the incoming call (step 104). The information received from the telephony switch 14 or gateway 24 is sufficient to identify the called party, and preferably, the caller, and as such, the service node 30 will initially identify the called party (step 106) and then apply the call processing rules for the called party to determine how the telephony switch 14 or gateway 24 should handle the incoming call (step 108). Next, the service node 30 will instruct the telephony switch 14 or gateway 24 to connect the call to the intended directory number, or to reroute the call to another directory number or to voicemail, based on the call processing rules (step 110). The telephony switch 14 or gateway 24 will then process the incoming call accordingly. Notably, the use of directory number (DN) is intended to encompass any type of telephony addressing, including Internet Protocol (IP) addresses or the like, used for routing packet-based voice communications. If and as calls are forwarded to telephony switches 14 servicing the various telephony devices under the instruction of the service node 30, each of the telephony switches 14 or gateways 24 will interact with the service node 30 as necessary to handle and direct the call according to the call processing rules defined by the user.

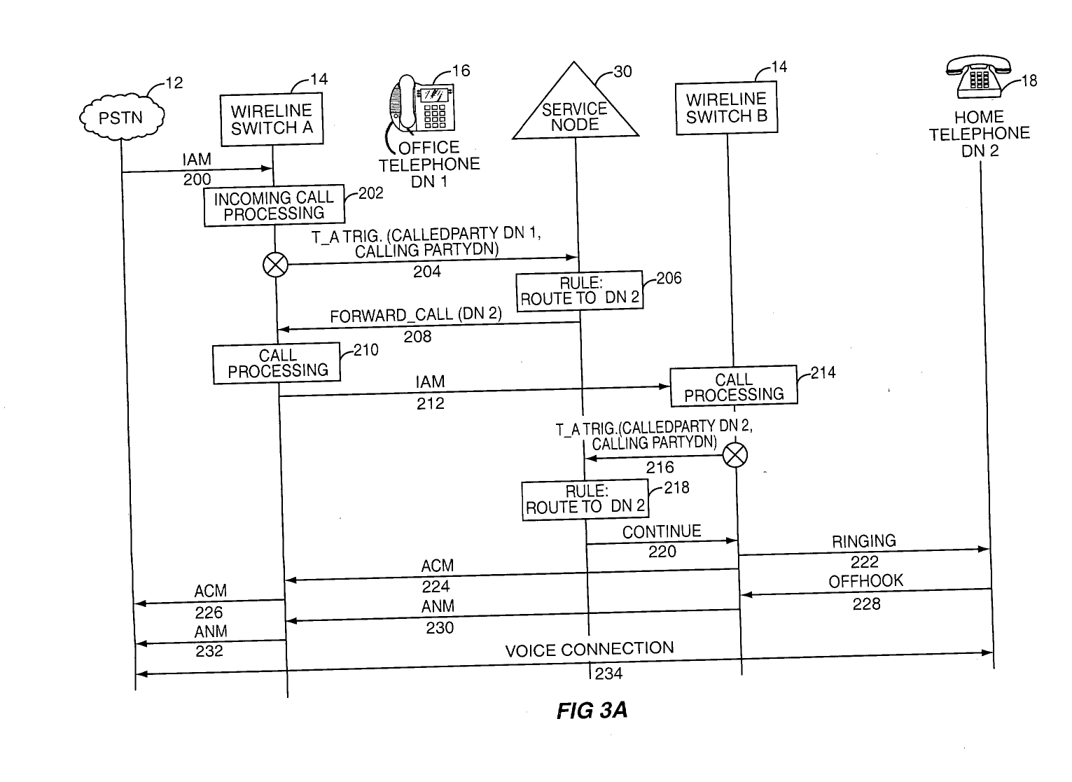

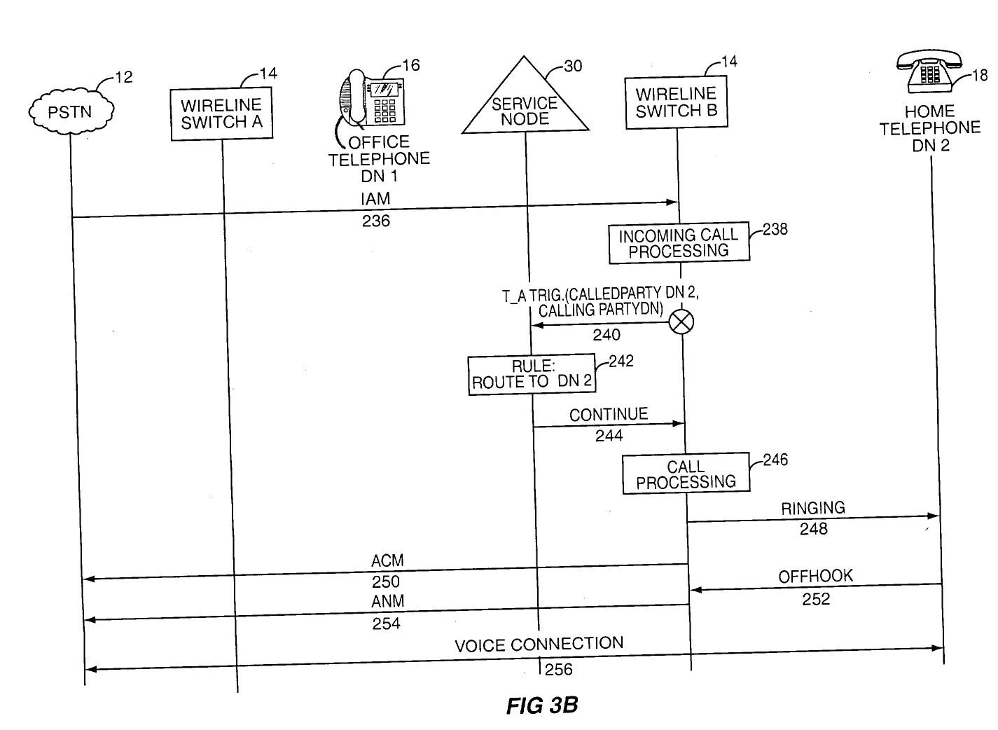

An exemplary call flow is provided in FIG. 3A, wherein an incoming call is originally intended for the user's office telephone 16, wherein the user has established call processing rules at the service node 30 to forward incoming calls directed to the office telephone 16 using directory number DN 1 to the home telephone 18, which is associated with directory number DN 2. As illustrated in FIG. 1, the office telephone 16 is serviced by wireline switch A (14), and the home telephone 18 is serviced by wireline switch B (14).

Initially, indication of an incoming call to the office telephone 16 is provided in an Initial Address message (IAM) sent to wireline switch A from a telephony switch in the PSTN 12 (step 200). Wireline switch A will recognize that the incoming call is intended for the office telephone 16 based on the office telephone's directory number DN 1 included in the IAM message during incoming call processing (step 202), and recognize that calls intended for the office telephone 16 should trigger the initiation of a termination attempt trigger message to the service node 30. Accordingly, a termination attempt trigger message (T_A TRIG.) is sent to the service node 30 and will identify the directory number for the called party, DN 1, and that of the caller, DN (step 204). The service node 30 will directly or indirectly receive the termination attempt trigger, identify the call processing rules based on the notification of the called party (DN 1), and determine how wireline switch A should process the incoming call (step 206). In this case, the rule applied indicates wireline switch A should route the incoming call to directory number DN 2, which is associated with the called party's home telephone 18. As such, the service node 30 will send instructions to wireline switch A to forward the call to directory number DN 2 (step 208). Wireline switch A will provide the requisite call processing (step 210) and send an IAM message directly or indirectly to wireline switch B, which services the home telephone 18 (step 212).

Wireline switch B will provide the requisite call processing (step 214), and recognize that incoming calls directed to the home telephone 18 require instructions from the service node 30. As such, a termination attempt trigger is sent to the service node 30 identifying the caller by directory number DN, and called party by the directory number for the home telephone 18, DN 2 (step 216). The service node 30 will identify the call processing rule set based on directory number DN 2, recognize that the call should be routed to the home telephone 18 (step 218) and send a continue message to wireline telephone switch B (step 220). Wireline switch B will cause the home telephone 18 to ring (step 222), as well as send an Address Complete message (ACM) to wireline switch A indicating that the home telephone 18 is ringing (step 224). Wireline switch A will forward the ACM message as necessary to the PSTN 12 and ultimately the originating switch (step 226). When the home telephone 18 is answered, wireline switch B will recognize that the home telephone 18 has gone offhook (step 228), which will trigger the sending of an Answer message ANM to wireline switch A (step 230), which will forward the ANM message to the PSTN 12 in traditional fashion (step 232). At this point, a voice connection is established between the home telephone 18 and the telephony device of the caller (step 234).

Turning now to FIG. 3B, assume the incoming call from the caller is made directly to the home telephone 18 using directory number DN 2. As such, the IAM message is sent directly to wireline switch B (step 236), which will provide the initial incoming call processing (step 238). Upon recognizing that the call is intended for directory number DN 2 and requires support from the service node 30, a termination attempt trigger is sent to the service node 30 identifying the directory numbers for the called party and caller (step 240). The service node 30 will identify the call processing rules to use based on the called party's directory number DN 2 and decide how wireline switch B should process the incoming call (step 242). Since calls to the user are supposed to be routed to the home telephone 18 associated with directory number DN 2 in this scenario, the service node 30 will cause wireline switch B to proceed in a normal fashion and route the call to the home telephone 18 by sending a continue message to wireline switch B (step 244). Wireline switch B will proceed with call processing (step 246) and begin ringing the home telephone 18 (step 248). Concurrently, wireline switch B will send an ACM message back to the PSTN 12 (step 250) and await answering of the home telephone 18. Upon being answered, wireline switch B will recognize that the home telephone 18 has gone offhook (step 252) and send an ANM message to the PSTN 12 (step 254) in traditional fashion. At this point, a voice connection is established between the home telephone 18 and the telephony device of the caller (step 256).

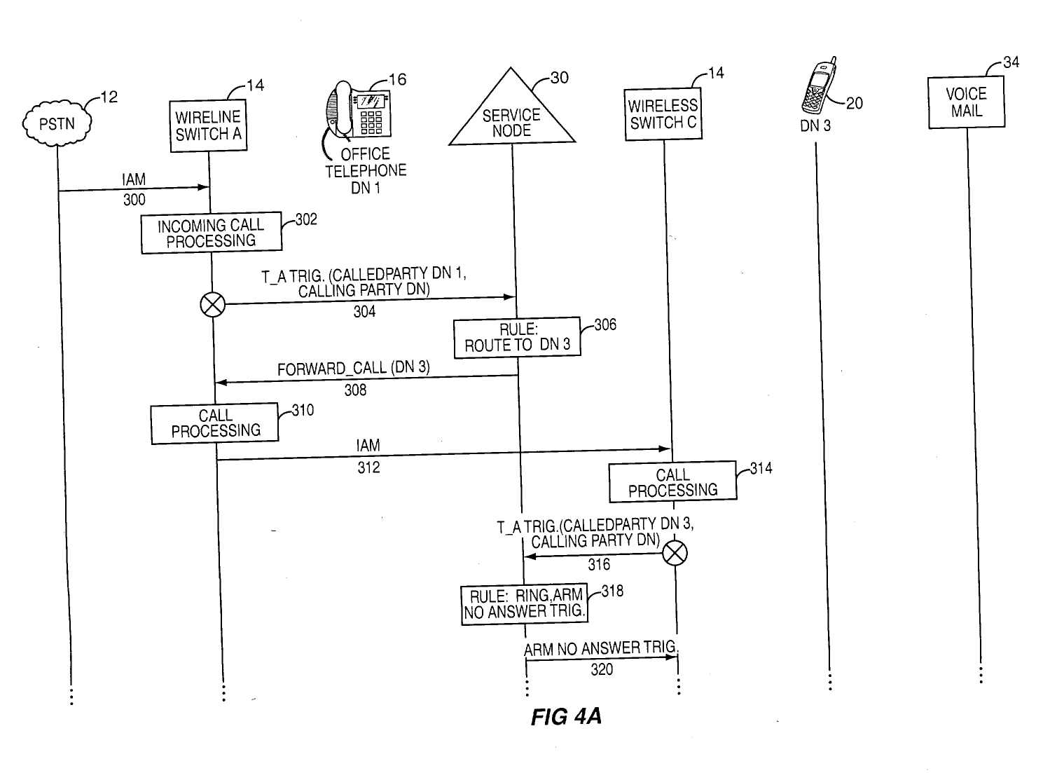

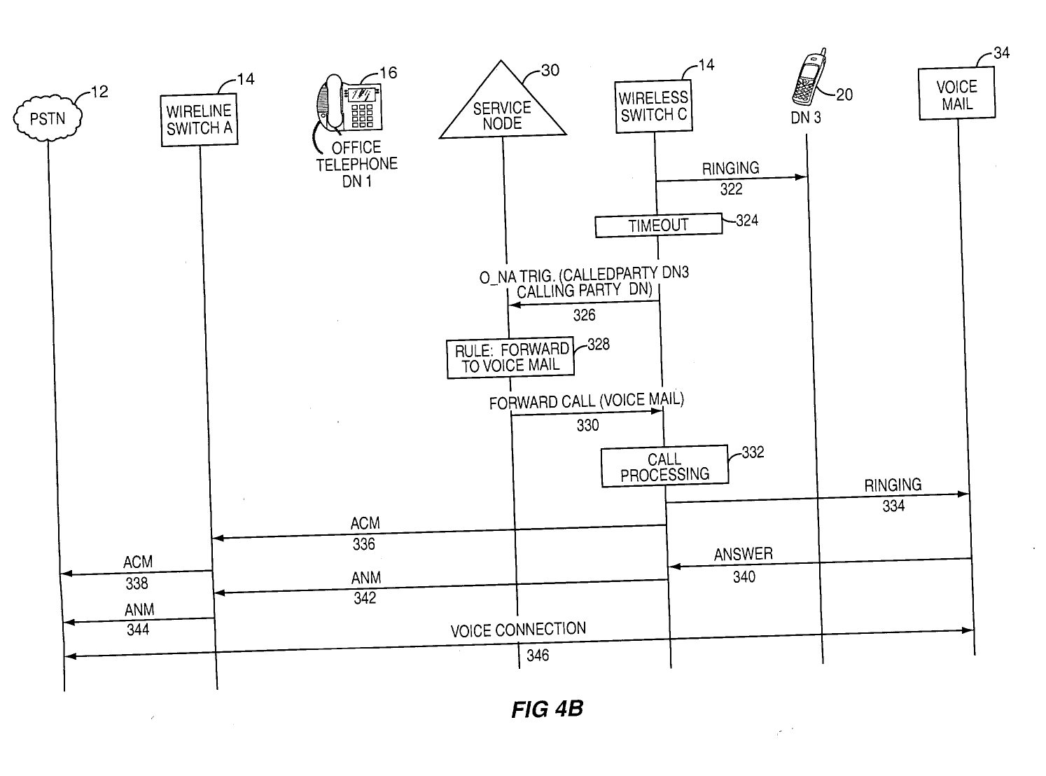

In the exemplary call flow of FIGS. 4A and 4B, an incoming call is intended for the office telephone 16, yet the service node 30 will cause the call to be forwarded to the mobile terminal 20, and if there is no answer at the mobile terminal 20, forward the call to the voicemail system 34. Preferably, the service node 30 will allow a common voicemail system 34 to service the user regardless of the device with which communications are intended for the user. Thus, incoming calls to the office telephone 16, home telephone 18, or mobile terminal 20 can all be sent to one voicemail system 34, which is accessible by the user from virtually any telephony communication device.

Initially, an IAM message is received by wireline switch A (14) indicating that a call is being initiated from a caller to the office telephone 16 (step 300). Wireline switch A will provide incoming call processing (step 302) and recognize that call processing instructions from the service node 30 are required. As such, a termination attempt trigger is sent to the service node 30 (step 304), which will identify the appropriate call processing rules based on the identification of the called party (step 306). In this case, the service node 30 determines to forward the call to directory number DN 3, which is associated with the mobile terminal 20, and will send a message to wireline switch A to forward the call to directory number DN 3 (step 308). Wireline switch A will continue call processing based on this information (step 310) and send an IAM message directly or indirectly to wireless switch C (14), which services the mobile terminal 20 (step 312). Wireless switch C will initiate call processing (step 314) and initiate a termination attempt trigger to the service node 30 (step 316). The service node 30 will identify the rules to apply based on the identification of the called party or the directory number, and determine that the call should be sent to the mobile terminal 20, and if the mobile terminal 20 is not answered, forward the call to voicemail.

As such, the service node 30 will send a message to wireless switch C to ring the mobile terminal 20 and arm a no answer trigger, which will cause wireless switch C to come back to the service node 30 for further instruction (step 320). As such, wireless switch C will cause the mobile terminal 20 to begin ringing (step 322). If the mobile terminal 20 is not answered, wireless switch C will ultimately time out (step 324), which will cause it to send an originating no answer trigger (O_NA TRIG.) message to the service node 30 (step 326). Again, the service node 30 will identify the appropriate rules to apply, recognizing in this instance that the call should be forwarded to voicemail since the mobile terminal 20 was not answered (step 328). As such, the service node 30 will send a message to wireless switch C to forward the call to voicemail (step 330). Wireless switch C will provide call processing (step 332) and initiate ringing of the voicemail system 34 for the user (step 334). Concurrently, wireless switch C will send an ACM message to wireline switch A (step 336), which will forward the ACM message to the appropriate telephony switch in the PSTN 12 (step 338). Once the voicemail system 34 answers (step 340), wireless switch C will send an ANM message to wireline switch A (step 342), which will forward the ANM message to the appropriate telephony switch in the PSTN 12 (step 344). At this point, a voice connection is established between the caller and the voicemail system 34 (step 346).

As seen from the above, allowing the telephony switches 14 or gateways 24 servicing various telephony devices of a given user to be coordinated for incoming calls to the user allows the user to effectively and efficiently control how calls are processed among any of the telephony devices, as well as provide a single voicemail system 34. The invention is particularly beneficial in allowing a user to effectively use her mobile terminal 20 in conjunction with her wireline work or home telephones 16, 18. By configuring the service node 30 to handle or otherwise process incoming calls to any of the telephony devices to a desired telephony device or a single voicemail system 34, all incoming calls, regardless of the originally intended telephony device, are efficiently controlled by the user. Further, the user avoids having voicemails left in different voicemail systems or answering machines, while making communications with her much more efficient for those initiating the calls. By controlling call processing via the service node 30 for multiple telephony devices having unique directory numbers, the user does not have to use multiple call forwarding systems in a rudimentary manner to control call handling. Further, call forwarding systems will not allow the associated telephony device to receive a call, and thus, call screening is not available.

A common scenario to most mobile terminal users is one where the user is in a meeting or participating in a conference call on an office telephone 16. The service node 30 may have a profile for the user specifically adapted for meeting situations. Further, in these situations, most incoming calls should be diverted to voicemail, but there are certain people, such as the user's boss, that should be able to contact the user at any given time, even when in meetings. As such, the meeting profile in the service node 30 may be configured to divert incoming calls directed to the office telephone 16 or the mobile terminal 20 to a common voicemail system 34 from all calling parties, except the user's boss, whose various directory numbers are provided to the service node 30. Thus, upon recognizing incoming calls to the office telephone 16 or mobile terminal 20 for the user, the service node 30 will direct the respective telephony switches 14 to forward the call to voicemail, unless the call is from the boss, in which case the call will be directed to the mobile terminal 20.

The user may also have a general office profile that directs calls that are made to the mobile terminal 20, office telephone 16, or other associated telephony device, to the office telephone 16. To further refine this profile, the user may decide to block calls from certain callers and have those calls automatically forwarded to the voicemail system 34. As those skilled in the art will recognize, various profiles based on user configuration, time and date, incoming or outgoing call identification, and the like, may be used to provide unlimited call processing rule sets. Each user may have any number of rule sets, and the service node 30 may support any number of telephony devices for a given user. Although a significant portion of the above disclosure is directed to wireline and wireless telephony communications, those skilled in the art will also recognize the ease with which call processing entities for packet-switched systems can interact with the service node 30 to facilitate the unified call processing of the present invention, and may support numerous users and their associated telephony devices. Notably, the term “user” used herein relates to any type of entity or individual, and the various telephony devices may be associated with multiple directory numbers.

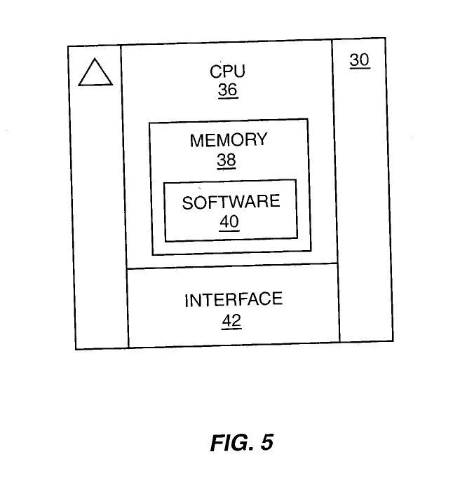

The service node 30 may take on many forms and be integrated with other call processing systems, as well as having numerous interfaces for effectively communicating directly or indirectly with the various telephony switches 14, gateways 24, or other packet-based call processing entities. As illustrated in FIG. 5, the service node 30 will typically be associated with a central processing unit (CPU) 36 having sufficient memory 38 for storing the necessary software 40 for implementing the concepts of the present invention. The CPU 36 will have a communication interface 42 for communicating directly or indirectly with the various telephony switches 14, gateways 24, or like call processing entities.

For additional call routing information, attention is directed to U.S. application Ser. No. ______ filed ______ and entitled USER CONTROLLED CALL ROUTING FOR MULTIPLE TELEPHONY DEVICES, the disclosure of which is hereby incorporated by reference in its entirety.

Those skilled in the art will recognize improvements and modifications to the preferred embodiments of the present invention. All such improvements and modifications are considered within the scope of the concepts disclosed herein and the claims that follow.

What is claimed is:

1. A method for allowing coordinated call processing among multiple telephony devices associated with an entity comprising:
a) establishing call processing rules for processing incoming calls to each of a plurality of telephony devices associated with an entity; and
b) for each incoming call to any one of the telephony devices:
i) receiving a message initiated by a switching device servicing the one of the telephony devices, the message indicative of an incoming call to be terminated at the telephony device;
ii) generating instructions defining how the switching device should process the incoming call based on the call processing rules; and
iii) effecting delivery of the instructions to the switching device, wherein the switching device will process the incoming call according to the instructions such that incoming calls to any of the plurality of telephony devices associated with the entity are processed in a coordinated fashion.

2. The method of claim 1 wherein the telephony devices are associated with different directory numbers or network addresses.

3. The method of claim 1 wherein at least two of the telephony devices are serviced by different switching devices.

4. The method of claim 1 wherein at least two of the telephony devices are supported by different communication networks.

5. The method of claim 4 wherein a first of the telephony devices is supported by a wireline network and a second of the telephony devices is supported by a wireless network.

6. The method of claim 1 wherein the instructions are adapted to cause the switching device to route the incoming call to another of the telephony devices.

7. The method of claim 1 wherein the instructions are adapted to cause the switching device to route the incoming call to a voicemail system.

8. The method of claim 1 wherein all incoming calls to any of the telephony devices are routed to a single voicemail system when routing to voicemail occurs.

9. The method of claim 1 wherein the instructions are adapted to cause the switching device to block the incoming call.

10. The method of claim 1 further comprising determining the identity associated with a caller and generating the instructions based on the identity of the caller.

11. The method of claim 10 wherein the instructions for a first caller are different than the instructions for a second caller

12. The method of claim 10 wherein the call processing rules facilitate call screening such that certain calls are routed to a select one of the telephony devices while others are routed to a voicemail system.

13. The method of claim 1 further comprising determining a time or date of the incoming call and generating the instructions based on the time or date.

14. The method of claim 1 further comprising determining line status and generating the instructions based on the line status.

15. The method of claim 1 further comprising determining a mobile terminal location and generating the instructions based on the mobile terminal location.

16. The method of claim 1 further comprising determining computer presence and generating the instructions based on the computer presence.

17. The method of claim 1 further comprising determining calendar information and generating the instructions based on the calendar information.

18. The method of claim 1 further comprising determining the one of the telephony devices to which the incoming call was originally directed and generating the instructions based on the one of the telephony devices.

19. The method of claim 1 wherein the instructions are adapted to cause the switching device to route the incoming call to the one of the telephony devices.

20. The method of claim 1 further comprising creating a plurality of profiles for the entity, each profile defining unique call processing rules to apply to the incoming calls to the telephony devices associated with the entity.

21. The method of claim 1 further comprising receiving information from the entity and establishing the call processing rules based on the information.

22. The method of claim 1 further comprising establishing call processing rules for a plurality of entities.

23. The method of claim 1 further comprising provisioning the switching devices serving the telephony devices to obtain call processing instructions from a service node when processing the incoming calls.

24. The method of claim 1 wherein the entity is an individual.

25. A system for allowing coordinated call processing among multiple telephony devices associated with an entity comprising:
a) an interface;
b) a processing system associated with the interface and adapted to:
i) establish call processing rules for processing incoming calls to each of a plurality of telephony devices associated with an entity; and
ii) for each incoming call to any one of the telephony devices:
(1) receive a message initiated by a switching device servicing the one of the telephony devices, the message indicative of an incoming call to be terminated at the telephony device;
(2) generate instructions defining how the switching device should process the incoming call based on the call processing rules; and
(3) effect delivery of the instructions to the switching device, wherein the switching device will process the incoming call according to the instructions such that incoming calls to any of the plurality of telephony devices associated with the entity are processed in a coordinated fashion.

26. The system of claim 25 wherein the telephony devices are associated with different directory numbers or network addresses.

27. The system of claim 25 wherein at least two of the telephony devices are serviced by different switching devices.

28. The system of claim 25 wherein at least two of the telephony devices are supported by different communication networks.

29. The system of claim 28 wherein a first of the telephony devices is supported by a wireline network and a second of the telephony devices is supported by a wireless network.

30. The system of claim 25 wherein the instructions are adapted to cause the switching device to route the incoming call to another of the telephony devices.

31. The system of claim 25 wherein the instructions are adapted to cause the switching device to route the incoming call to a voicemail system.

32. The system of claim 25 wherein all incoming calls to any of the telephony devices are routed to a single voicemail system when routing to voicemail occurs.

33. The system of claim 25 wherein the instructions are adapted to cause the switching device to block the incoming call.

34. The system of claim 25 wherein the processing system is further adapted to determine the identity associated with a caller and generate the instructions based on the identity of the caller.

35. The system of claim 34 wherein the instructions for a first caller are different than the instructions for a second caller

36. The system of claim 34 wherein the call processing rules facilitate call screening such that certain calls are routed to a select one of the telephony devices while others are routed to a voicemail system.

37. The system of claim 25 wherein the processing system is further adapted to determine a time or date of the incoming call and generate the instructions based on the time or date.

38. The system of claim 25 wherein the processing system is further adapted to determine the one of the telephony devices to which the incoming call was originally directed and generate the instructions based on the one of the telephony devices.

39. The system of claim 25 wherein the instructions are adapted to cause the switching device to route the incoming call to the one of the telephony devices.

40. The system of claim 25 wherein the processing system is further adapted to create a plurality of profiles for the entity, each profile defining unique call processing rules to apply to the incoming calls to the telephony devices associated with the entity.

41. The system of claim 25 wherein the processing system is further adapted to receive information from the entity and establish the call processing rules based on the information.

42. The system of claim 25 wherein the processing system is further adapted to establish call processing rules for a plurality of entities.

43. The system of claim 25 wherein the entity is an individual.
